(19) United States
(12) Patent Application Publication
(10) Pub. No.: US 2019/0205469 A1
(43) Pub. Date: Jul. 4, 2019

(54) COGNITIVE SYSTEM AND METHOD TO SELECT BEST SUITED AUDIO CONTENT BASED ON INDIVIDUAL'S PAST REACTIONS

(71) Applicant: International Business Machines Corporation, Armonk, NY (US)

(72) Inventors: Hernan A. Cunico, Holly Springs, NC (US); Asima Silva, Holden, MA (US)

(21) Appl. No.: 15/861,852

(22) Filed: Jan. 4, 2018

(51) Int. Cl. G06F 17/30; G06Q 30/02

(52) U.S. Cl. CPC G06F 17/30766; G06Q 30/0201; G06Q 30/0276; G06F 17/30752; G06Q 30/0271

(57) ABSTRACT

A cognitive media processing system for selective and adaptive modification of digital content with an audible element. In various examples, the cognitive media processing system obtains digital content and a desired reaction of a plurality of users for when the digital content is displayed on a plurality of user computing devices. The system obtains a plurality of user reaction profiles for the plurality of users. The system determines a first audio file of a plurality of audio files for a first user computing device based on the desired reaction and a first user reaction profile. The system then updates the digital content to include the first audio file to produce first updated digital content and sends the first updated digital content to the first user computing device.

### BACKGROUND

This invention relates to social computing, collaboration and communications and more specifically, to providing audio-visual content to a user.

In prior art digital content systems, a sender transmits digital content to recipients. A first recipient receives the digital content with the same elements as a second recipient. In some cases, the sender may wish to invoke a reaction from the recipient. For example, a flower shop may want to invoke a happy emotion and thus chooses a popular love song to play during its advertisements. However, the first and second recipients both receive an advertisement for flowers with the same love song being played during the advertisement. In some situations, one of the recipients may have a negative or non-happy reaction to the specific love song, which may adversely affect the effectiveness of the advertisement.

### SUMMARY

Embodiments of the present invention disclose a computer-implemented method, a system, and a computer program product for selective and adaptive modification of digital content with an audible element. Digital content and a desired reaction of a plurality of users to the digital content, is obtained by a computing device of a digital communication network for when the digital content is displayed on a plurality of user computing devices. A plurality of user reaction profiles is obtained for the plurality of users. A first audio file of a plurality of audio files for the first user is determined based on the desired reaction and the first user reaction profile. The digital content is updated to include the first audio file to produce first updated digital content. The first updated digital content is sent to the first user computing device.

### BRIEF DESCRIPTION OF THE SEVERAL VIEWS OF THE DRAWING(S)

FIG. 1 is a schematic block diagram of an example of a cognitive media system in accordance with an embodiment of the present disclosure;

FIG. 2 is a schematic block diagram of another example of a cognitive media system in accordance with an embodiment of the present disclosure;

FIG. 3A is a schematic block diagram of a specific example of a cognitive media system in accordance with an embodiment of the present disclosure;

FIG. 3B is a schematic block diagram of a specific example of a cognitive media system in accordance with an embodiment of the present disclosure;

FIG. 4 is a flow diagram illustrating an example of updating digital content in accordance with an embodiment of the present disclosure;

FIG. 5 depicts a block diagram of a computing device according to various embodiments of the present disclosure;

FIG. 6 depicts a cloud computing environment according to various embodiments of the present disclosure; and

FIG. 7 depicts abstraction model layers according to various embodiments of the present disclosure.

### DETAILED DESCRIPTION OF THE INVENTION

Some digital content (e.g., presentations, advertisements, promotional video, etc.) may be enhanced by audio, which in context with the digital content may have a desired effect (e.g., causing an emotion) on the recipients. The audio is selected by the editor to induce the desired effect. However, when exposed to the selected audio, one recipient may have the desired reaction while another recipient may have a drastically different and unintended reaction. The novel methods and systems described below provide techniques for personalizing and predicting an audible element of digital content that will produce the desired reaction for individual recipients, such that the intended effect for the digital content is realized for each recipient.

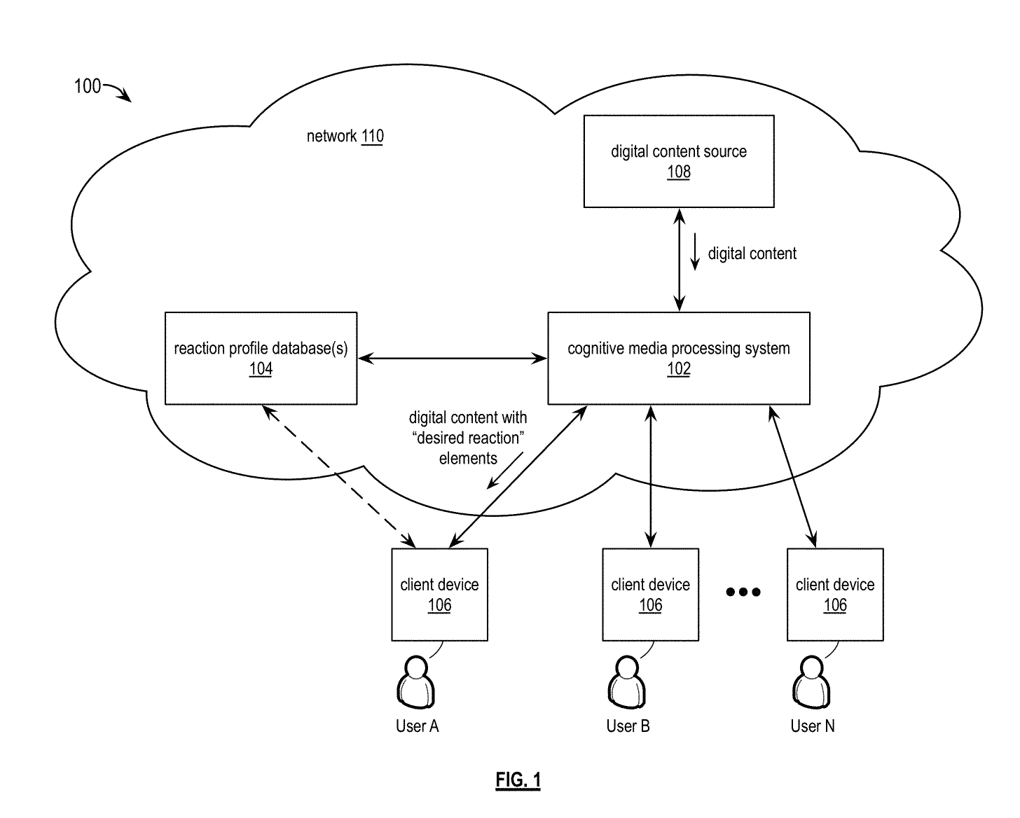

FIG. 1 depicts a cognitive media system 100 in accordance with an embodiment of the present disclosure. The illustrated cognitive media system includes a cognitive media processing system 102, a reaction profile database(s) 104, a plurality of client devices 106 associated with a plurality of users A-N, and a digital content source 108. The components of the digital communications network 100 are coupled via a network 110, which may include one or more wireless and/or wire lined communication systems; one or more non-public intranet systems and/or public internet systems; and/or one or more local area networks (LAN) and/or wide area networks (WAN).

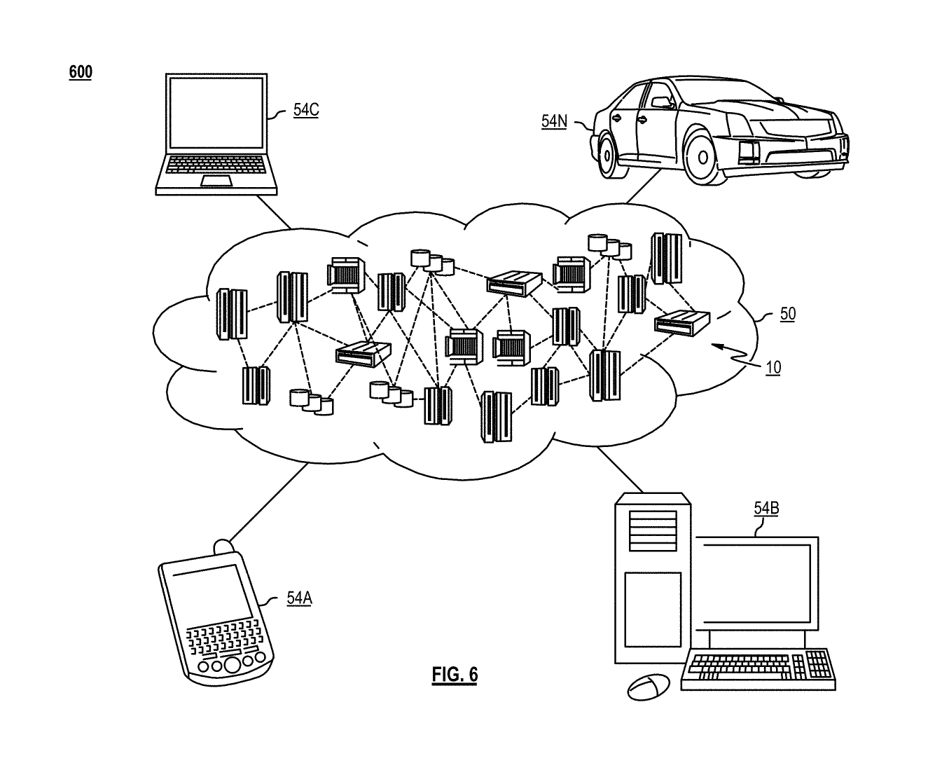

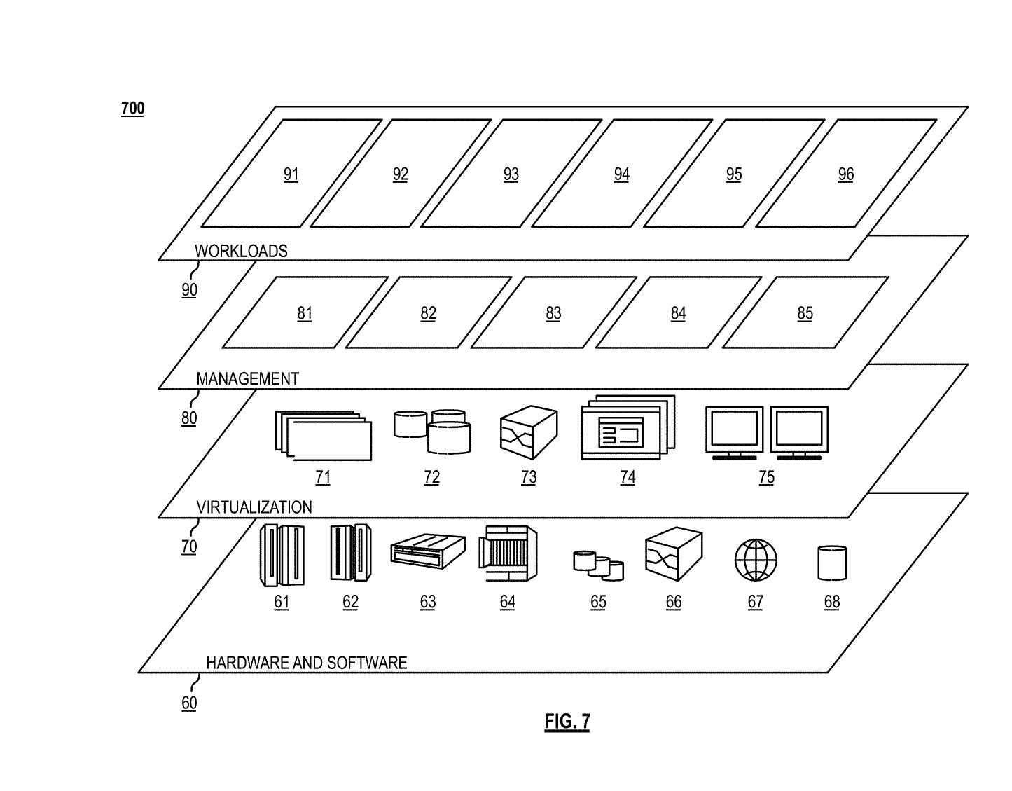

In some embodiments, network 110 can be implemented by utilizing the cloud computing environment 50 of FIG. 6, for example, by utilizing the streaming video processing 96 of the workloads layer 90 of FIG. 7 to perform streaming video processing in the network. The cognitive media processing system 102 and reaction profile database(s) 104 can be implemented by utilizing one or more nodes 10 of a cloud computing environment 50 of FIG. 6.

Client devices 106 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, home entertainment equipment, a video game console, and/or any type of home or office computing equipment.

Each client device 106 includes software and hardware to support one or more communication links via the network 110 indirectly and/or directly. For example, a client device 106 can include an interface that supports a communication link (e.g., wired, wireless, direct, via a LAN, via the network 110, etc.) with the cognitive media processing system 102. As another example, a client device 106 interface can support communication links (e.g., a wired connection, a wireless connection, a LAN connection, and/or any other type of connection to/from the network 110) with one or more systems that generate and/or maintain the reaction profile database(s) 104. In certain embodiments, the reaction profile database(s) 104 may be fully or partially supported, maintained or curated by the cognitive media processing system 102.

As described more fully below, the cognitive media processing system 102 generally operates provide digital content from one or more digital content sources 108 to client devices 106. As an example, client device requests for a user may be generated automatically (e.g., upon the user opening a social media application on a client device) or based on a user input to a client device (e.g., selection of a link). As another example, a digital content provider may request to send digital content to one or more client devices. Upon receiving a request, the cognitive media processing system 102 correlates a reaction profile of a user against desired reaction elements associated with the requested digital content to identify elements of the digital content that may be modified according to the user's reaction profile. Such elements of the digital content (which may be referred to herein as advertisements, media, promotion, or like terminology) may then be updated to produce updated digital content. For example, a segment (e.g., element) of an audiobook may have a desired reaction tag (e.g., annotation, metadata, etc.) of “excitement.” A user's reaction profile may indicate an audio file (e.g., song segment 2) that correlates to an excitement emotion. Thus, in this example, the cognitive media processing system 102 updates the audiobook element to include song segment 2.

A reaction profile associated with a user of a client device can also include one or more characteristics such as demographic information (age, gender, location, etc.), social media activity related information (e.g., check-ins, posts, “likes”, “follows”), or browsing history information, information derived from on-line forms and surveys, etc. As an example, a user “Alice” mentions on social media in a post that she loves Song A that was just played on the radio, because it was her wedding song.

The cognitive media processing system 102 assess through sentiment analysis and semantic analysis of social media, that Alice's' marital relationship has a happy sentiment. Some examples of the analysis include determining a recent repost of anniversary vacation photos, determining Alice's social media status currently indicates married, etc. The cognitive media processing system 102 updates digital content requested to be consumed by the client device 106 associated with Alice such that during a romantic scene or advertisement (e.g., jewelry), Song A is played with the digital content. In one embodiment, user reactions to digital content are assessed and updated in real time (e.g., facial recognition while wedding song is being played indicates a happy emotion, etc.).

In one embodiment, the cognitive media processing system may determine a first genre of a plurality of genres for a first group of user computing devices based on the desired reaction and user reaction profiles associated with the first group of user computing devices (e.g., client devices 106). The cognitive media processing system may determine a second genre of a plurality of genres for a second group of user computing devices based on the desired reaction and user reaction profiles associated with the second group of user computing devices. The cognitive media processing system may then select the first audio file based on the first genre, update the digital content to include the first audio file to produce first updated digital content, and send the first updated digital content to the first group of user computing devices. The cognitive media processing system may then select the second audio file based on the second genre, update the digital content to include the second audio file to produce second updated digital content, and send the second updated digital content to the second group of user computing devices.

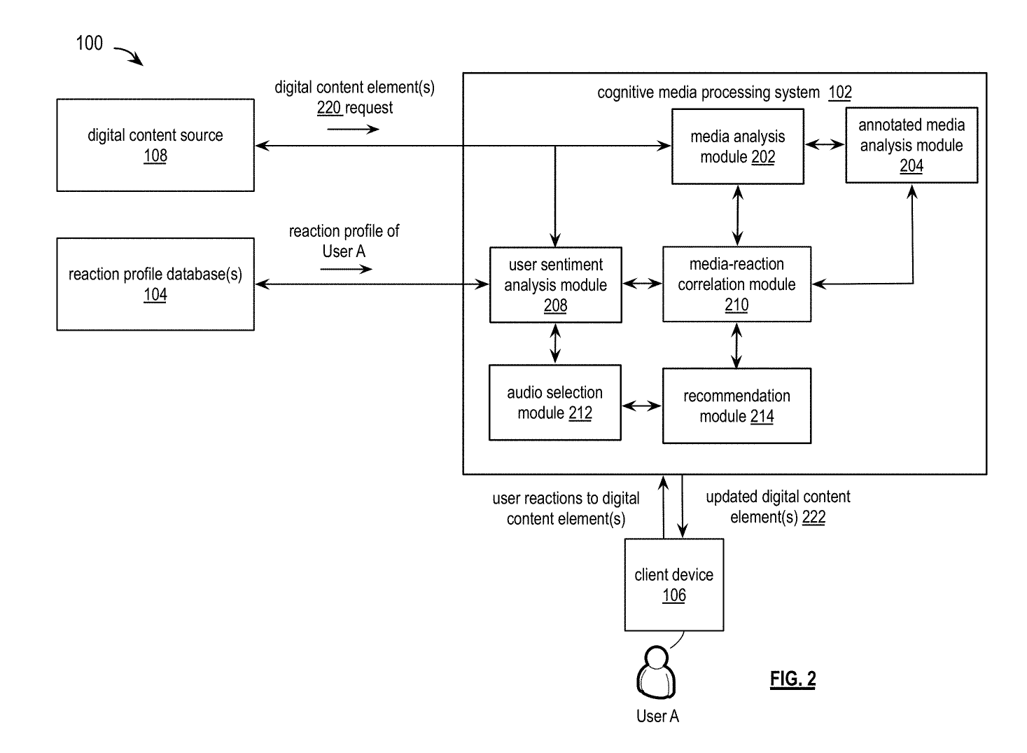

FIG. 2 is a schematic block diagram of another example of a cognitive media system 100 that includes the cognitive media processing system 102, reaction profile database(s) 104, a client device 106, and digital content source 108 of FIG. 1. In the illustrated example, the cognitive media processing system 102 includes a media analysis module 202, an annotated media analysis module 204, a user sentiment analysis module 208, a media-reaction correlation module 210, an audio selection module 212, and a recommendation module 214. In one example, the reaction profile database 104 is curated separately from the cognitive media processing system 102. In other examples, the cognitive media processing system 102 may maintain an internal reaction profile database, or supplement an internal reaction profile database with reaction profile information from a separate reaction profile database 104. Reaction profile information for users of the cognitive media processing system 102 may be updated on a periodic basis, on a scheduled basis, in real time, on demand, etc.

In one embodiment, the media analysis module 202 analyzes (e.g., by dissecting media) digital content that is driving the user sentiment analysis module 208 in order to determine the content of the media, tone, sentiment and any associated audio. The media analysis module 202 may create a matrix that correlates different elements of the digital content analyzed over a timeline. In another embodiment, the media analysis module 202 analyzes digital content provided from the digital content source 108 to determine media content elements associated with digital content received from the digital content source 108 and delivered (e.g., with updated audio specific to user A's reaction profile) to the client device 106 for consumption by User A.

The annotated media analysis module 204 analyzes new (e.g., future) digital content (e.g., a pre-recorded presentation, a portion of an advertisement, an audiobook, etc.) that is about to be exposed to a user of a client device. In one embodiment, the annotated media analysis module 204 performs the same analysis as performed by the media analysis module 202 on the new digital content and also performs an analysis on the new digital content for any annotations present within the digital content. For example, an audiobook may include annotations of how certain portions (e.g., elements) should be accentuated and/or any other emotional direction (e.g., reaction) that would enhance the exposure to the digital content. The annotated media analysis module 204 may create a matrix that correlates the various digital content element, analyzed over a timeline, with the associated sentiment embedded (e.g., annotated) in the digital content.

The user sentiment analysis module 208 operates to determine how a user of a client device reacts to digital content (e.g., videos, commercials, etc.). The user sentiment analysis module 208 may use a combination of smart and wearable devices, semantic and sentiment analysis on communications (e.g., conversations, social media, etc.) to determine how a user reacts to specific audio (e.g., audible variances, sounds, effect (FX) sounds, music, voice tones, etc.).

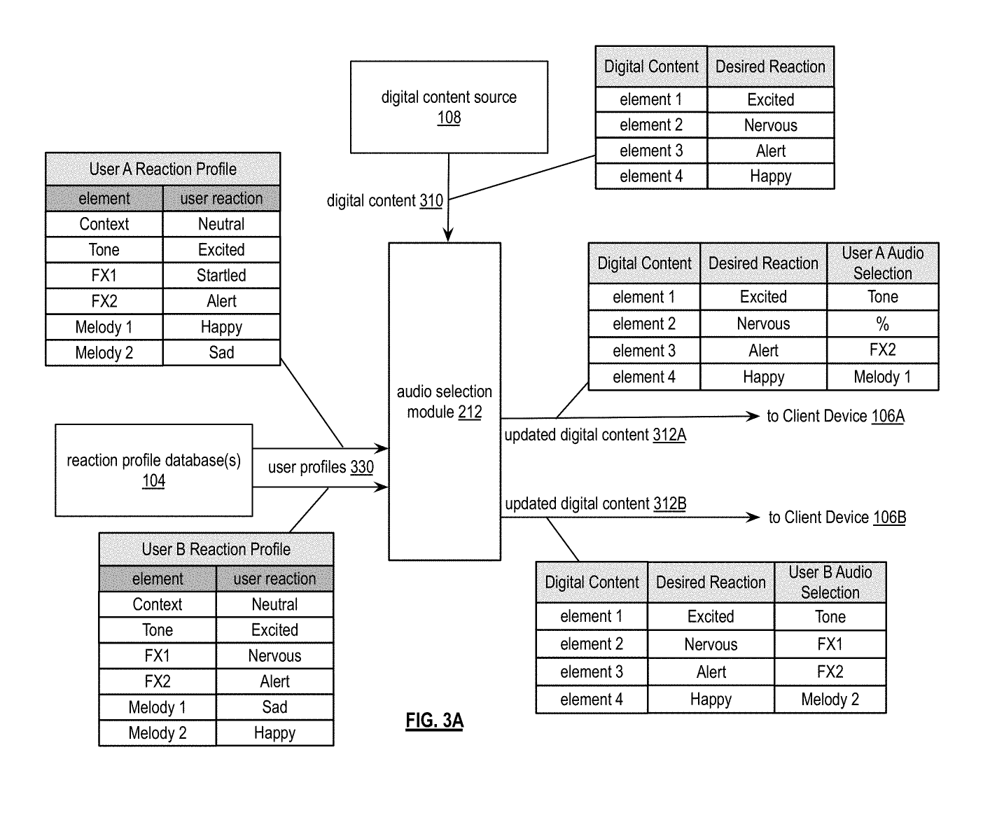

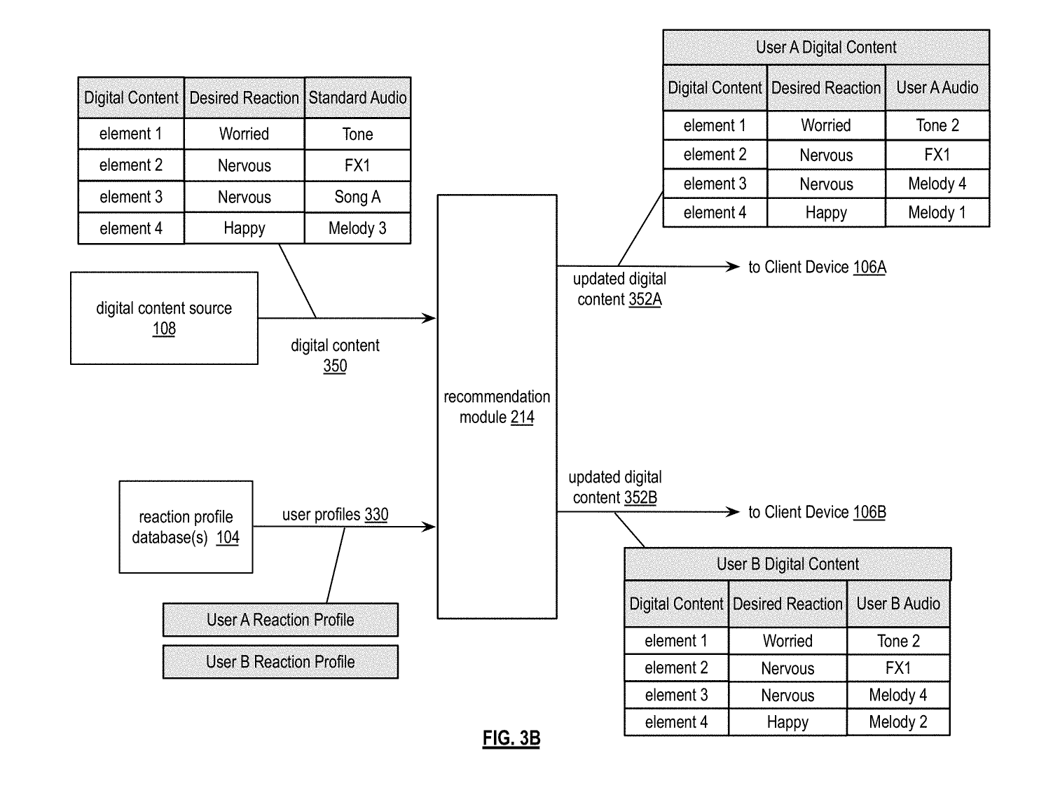

The media reaction correlation module 210 operates to create a correlation table based on the outputs of the user sentiment analysis module 208 and the media analysis module 202. In one embodiment, the media reaction correlation module 210 may output a data pair involving an element and reaction to different audible variances (e.g., User Media-Reaction Correlation Table of FIG. 3A).

The audio selection module 212 operates to use historic analysis performed by the user sentiment analysis module 208 to create an extrapolation table, which pairs digital content elements with their intended sentiment and corresponding audio specific to a user of a client device. In one embodiment, the recommendation module 214 operates to use data from the audio selection module 212 to automatically replace audio on new digital content (e.g., based on the user's reaction profile, based on an annotation, etc.). In another embodiment, the recommendation module 214 operates to use data from the audio selection module 212 to recommend and allow a user to accept alternate audio files for the digital content.

In one example of operation, a user of client device 106 (“Alice”) has a user reaction profile that includes her age. The cognitive media processing system 102 determines that Alice's age group grew up when Jaws was a popular movie and that the Jaws soundtrack is associated with reaction emotion of danger approaching. Thus, cognitive media processing system 102 correlates the soundtrack with reactions “startled” and “horror” for Alice's reaction profile. When Alice is consuming digital content (e.g., reading an audiobook, viewing a commercial, etc.) during suspense scenes or advertisements (e.g., security system commercial), the cognitive media processing system 102 operates to update the digital content such that the Jaws soundtrack will play audibly during the suspense scenes.

FIG. 3A is a schematic block diagram of a specific example of a cognitive media processing system, that includes reaction profile database(s) 104, digital content source 108, and an audio selection module 212. In an example of operation, the audio selection module 212 receives user profiles 330 (e.g., sentiment data and media analysis data) from the reaction profile database(s) 104. Two examples of sentiment data/media analysis data are illustrated as User A and User B reaction profiles, which include an element column field with media analysis data and a user reaction column field with sentiment data.

In this example, the media analysis data (e.g., element column field) includes context, tone, sound effect 1 (FX1), sound effect 2 (FX2), melody 1 and melody 2. User A and B both have a user reaction of neutral for context, excited for tone, and alert for sound effect 2. However, User A and B differ in user reaction for sound effect 1, and melodies 1 and 2. For example, for user A melody 1 is correlated with a happy user reaction, while for user B melody 1 is correlated with a sad user reaction. In this example, a digital content element that has a desired reaction of “happy” would cause the desired reaction by playing melody 1 for user A, but would cause an opposite reaction of “sad” for user B.

In an embodiment, the audio selection module 212 also receives digital content 310 from the digital content source 108. The digital content 310 includes digital content elements and a corresponding desired reaction for the elements. In this example, the digital content includes element 1 with a corresponding desired reaction of excited, element 2 with a corresponding desired reaction of nervous, element 3 with a corresponding desired reaction of alert, and element 4 with a corresponding desired reaction of happy.

Continuing with the example, the audio selection module 212 updates the digital content for users A and B based on the users' reaction profiles to pair a user reaction with a corresponding desired reaction for each element. For example, for user A, element 1 is updated to include tone, element 2 is updated to include %, element 3 is updated to include Song B, and element 4 is updated to include melody 1. The % denotes that user profile A does not include an audio file that correlates to a “nervous” user reaction. In one embodiment, the audio selection module may choose a generic audio file (e.g., FX4) that is commonly associated with a nervous user reaction. For example, in the cognitive processing media system, FX4 is correlated with a nervous user reaction in 88.4% of profiles that include FX4. In another embodiment, the audio selection module may send user A's profile to the recommendation module 214, which will prompt the user with a selection of audio files for the user to select for association with a nervous user reaction.

Having updated the digital content to produce updated digital content 312A, the audio selection module may send, or cause another computing device of the cognitive media processing system to send, the updated digital content 312A to client device 106A. The audio selection module also updates the digital content according to user B's user profile 330 to produce updated digital content 312B and sends the updated digital content 312B to client device 106B.

FIG. 3B is a schematic block diagram of a specific example of a cognitive media system that includes reaction profile database(s) 104, digital content source 108, and recommendation module 214. In an example of operation, the recommendation module 214 receives digital content 350 from digital content source 108 and receives user profiles 330 from the reaction profile database(s) 104. The digital content 350 includes media (e.g., digital content elements, standard audio, etc.) and metadata (e.g., an information table) for elements of the digital content and a corresponding desired reaction for the elements. In various embodiments, the standard audio may be included in the digital content or may be metadata indicating the audio file, which may be later obtained by the recommendation module 214.

In this example, the digital content 350 includes element 1 with a corresponding desired reaction of worried and standard audio of tone, element 2 with a corresponding desired reaction of nervous and standard audio of FX1, element 3 with a corresponding desired reaction of alert and standard audio of song A, and element 4 with a corresponding desired reaction of happy and standard audio of melody 3. In one embodiment, the recommendation module receives the digital content 350 and user profiles 330 from the audio selection module 212.

In one embodiment, the recommendation module 214 recommends to the user audio for each element (e.g., elements 1-4) of the digital content 350. The user then selects audio for the elements based on the recommendation. For example, the user selects tone 2 for element 1, FX1 for element 2, melody 4 for element 3 and melody 1 for element 4. The recommendation module 214 then updates digital content 350 for user A to produce updated digital content 352A. The recommendation module 214 then sends the updated digital content to client device 106A (e.g., client device 106 associated with user A).

In one embodiment, the recommendation module 214 recommends to the user audio for some elements (e.g., elements 1 and 3) of the digital content 350 and automatically replaces audio for other elements (e.g., elements 2 and 4 (e.g., elements that have a corresponding user reaction in user B reaction profile)) of the digital content 350. The user then selects audio for the elements 1 and 3 based on the recommendation. For example, the user selects tone 2 for element 1 and melody 4 for element 3. The recommendation module 214 updates digital content 350 for user B to produce updated digital content 352B. The recommendation module 214 then sends the updated digital content to client device 106B (e.g., client device 106 associated with user B).

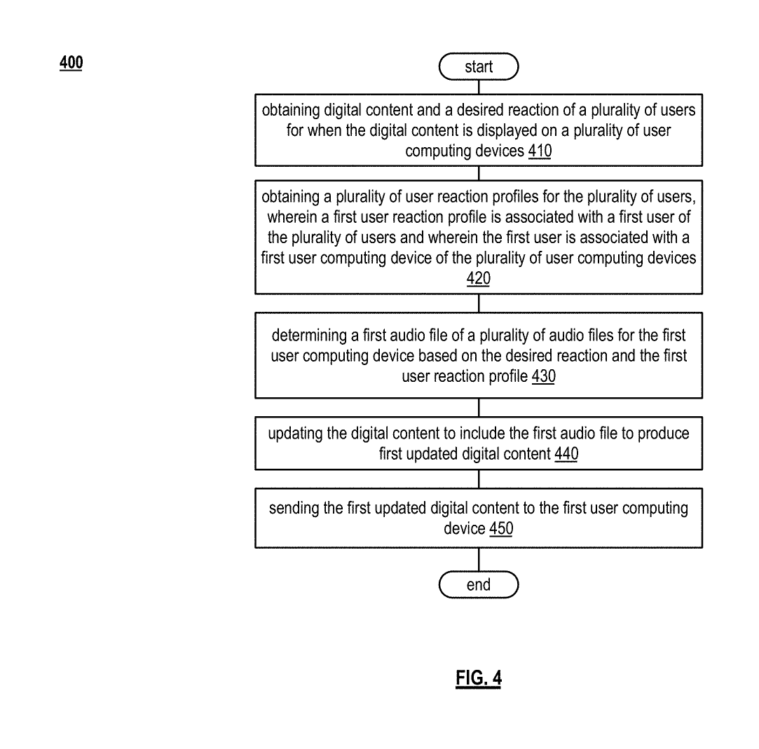

FIG. 4 is a flow diagram illustrating an example 400 of updating digital content in accordance with an embodiment of the present disclosure. In particular, a method is presented for use in association with one or more functions and features described in conjunction with FIGS. 1-3B, for execution by a cognitive media processing system that includes a processor, or via another device and/or system of a cognitive media processing system, that includes at least one processor and memory that stores instructions that configure the processor or processors to perform the steps described below.

Step 410 includes obtaining digital content and a desired reaction of a plurality of users for when the digital content is displayed on a plurality of user computing devices (e.g., client devices 106). The plurality of users is associated with the plurality of user computing devices. In step 420, the cognitive media processing system obtains a plurality of user reaction profiles for the plurality of users. A first user reaction profile of the plurality of user reaction profiles is associated with a first user of the plurality of users and the first user is associated with a first user computing device (e.g., client device) of the plurality of user computing devices. The first user reaction profile includes a first reaction to a first segment of the digital content and a second reaction to a second segment of the digital content.

In one embodiment to create or update a first user profile, the cognitive media processing system implements a media analysis function to produce media analysis data of the digital content. The media analysis function analyzes the digital content to determine one or more elements of the digital content. The media analysis data includes the one or more elements, which include content type, tone, sentiment and associated audio. The cognitive media processing system also implements a sentiment analysis function to produce sentiment analysis data regarding the first user. The sentiment analysis function analyzes how the first user reacts to at least one of the elements of the digital content. The sentiment analysis data includes one or more user reactions. The cognitive media processing system also implements a media reaction correlation function based on the sentiment analysis data and the media analysis data to create or update the first user reaction profile.

The method continues with step 430, where the cognitive media processing system determines a first audio file of a plurality of audio files for the first user computing device based on the desired reaction and the first user reaction profile. The first user reaction profile includes a listing of reactions of the first user to a variety of audible variances (e.g., reactions to genres, to specific songs, to FXs, to jingles, etc.). The method continues with step 440, where the cognitive media processing system updates the digital content to include the first audio file to produce first updated digital content. In one embodiment of updating the digital content, the cognitive media processing system implements an annotated media analysis function to produce annotated media data regarding second digital content. The annotated media analysis function analyzes the second digital content to determine a second desired reaction for the plurality of users corresponding to one or more annotated elements of the second digital content. The cognitive media processing system also implements an audio selection function on one or more of the sentiment analysis data, the media analysis data and the annotated media data to produce one or more estimated audio file selections for the one or more annotated elements. The one or more estimated audio file selections is based on the second desired reaction. The cognitive media processing system also implements a recommendation function on the estimated audio selection to pair a corresponding audio file of the plurality of files with an element of the one or more annotated elements of the second digital content. In some embodiments, the second digital content may be the digital content.

The method continues with step 450, where the cognitive media processing system sends the first updated digital content to the first user computing device. In one embodiment, the cognitive media processing system may perform the above steps for a second user.

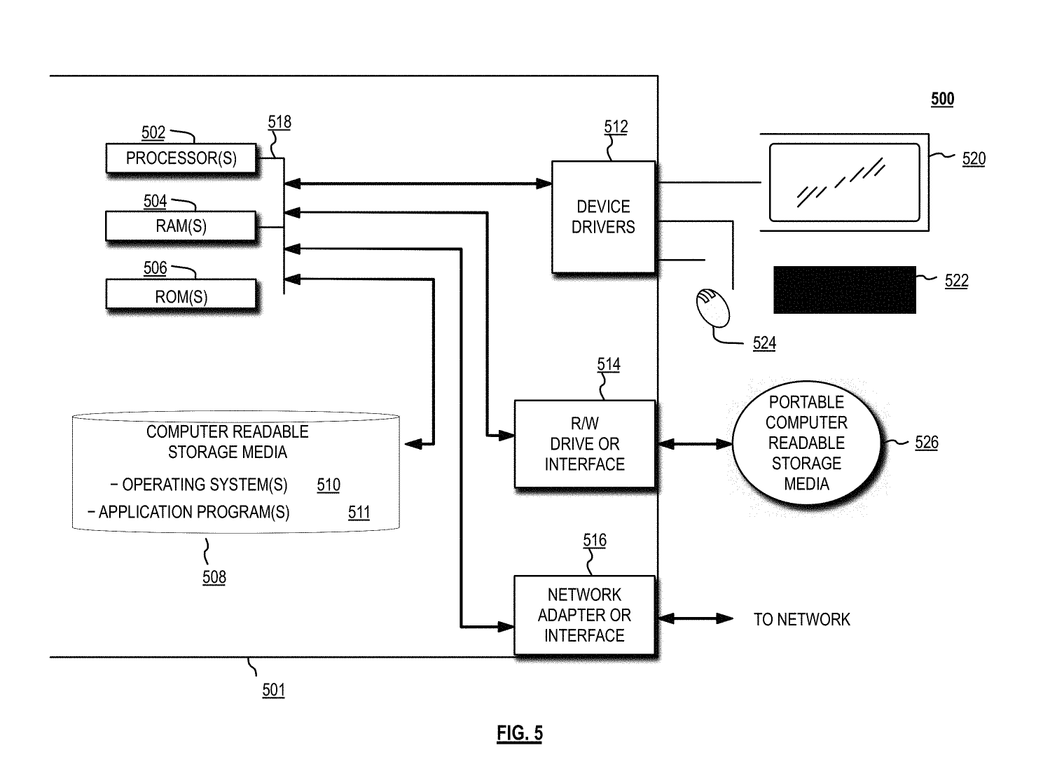

FIG. 5 depicts a block diagram of components of a computing device 500, which can be utilized to implement some or all of the cloud computing nodes 10, some or all of the computing devices 54A-N of FIG. 6, and/or to implement other computing devices/servers described herein in accordance with an embodiment of the present invention. It should be appreciated that FIG. 6 provides only an illustration of one implementation and does not imply any limitations with regards to the environments in which different embodiments may be implemented. Many modifications to the depicted environment may be made.

Computing device 500 can include one or more processors 502, one or more computer-readable RAMs 504, one or more computer-readable ROMs 506, one or more computer readable storage media 508, device drivers 512, read/write drive or interface 514, and network adapter or interface 516, all interconnected over a communications fabric 518. Communications fabric 518 can be implemented with any architecture designed for passing data and/or control information between processors (such as microprocessors, communications and network processors, etc.), system memory, peripheral devices, and any other hardware components within the system.

One or more operating systems 510 and/or application programs 511, such as network application server software 67 and database software 68, are stored on one or more of the computer readable storage media 508 for execution by one or more of the processors 502 via one or more of the respective RAMs 504 (which typically include cache memory). In the illustrated embodiment, each of the computer readable storage media 508 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the invention.

Computing device 500 can also include a R/W drive or interface 514 to read from and write to one or more portable computer readable storage media 526. Application programs 511 on computing devices 500 can be stored on one or more of the portable computer readable storage media 526, read via the respective R/W drive or interface 514 and loaded into the respective computer readable storage media 508.

Computing device 500 can also include a network adapter or interface 516, such as a TCP/IP adapter card or wireless communication adapter. Application programs 511 on computing devices 54A-N can be downloaded to the computing device from an external computer or external storage device via a network (for example, the Internet, a local area network or other wide area networks or wireless networks) and network adapter or interface 516. From the network adapter or interface 516, the programs may be loaded into the computer readable storage media 508. The network may comprise copper wires, optical fibers, wireless transmission, routers, firewalls, switches, gateway computers and edge servers.

Computing device 500 can also include (or otherwise be associated with) a display screen 520, a keyboard or keypad 522, and a computer mouse or touchpad 524. Device drivers 512 interface to display screen 520 for imaging, to keyboard or keypad 522, to computer mouse or touchpad 524, and/or to display screen 520 for pressure sensing of alphanumeric character entry and user selections. The device drivers 512, R/W drive or interface 514, and network adapter or interface 516 can comprise hardware and software stored in computer readable storage media 508 and/or ROM 506.

FIG. 6 presents an illustrative cloud computing environment 50. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, a set of functional abstraction layers provided by cloud computing environment 50 of FIG. 6 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. In some embodiments, one or more hardware components can be implemented by utilizing the computing device 500 of FIG. 5.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and streaming video processing 96, such as described above.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

The present invention may be a system, a method, and/or a computer program product at any possible technical detail level of integration. The computer program product may include a computer readable storage medium (or media) having computer readable program instructions thereon for causing a processor to carry out aspects of the present invention.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
obtaining, by a computing device of a digital communication network, digital content and a desired reaction of a plurality of users for when the digital content is displayed on a plurality of user computing devices, wherein the plurality of users is associated with the plurality of user computing devices;
obtaining, by the computing device, a plurality of user reaction profiles for the plurality of users, wherein a first user reaction profile is associated with a first user of the plurality of users and wherein the first user is associated with a first user computing device of the plurality of user computing devices;
determining, by the computing device, a first audio file of a plurality of audio files for the first user computing device based on the desired reaction and the first user reaction profile, wherein the first user reaction profile includes a listing of reactions of the first user to a variety of audible variances;
updating, by the computing device, the digital content to include the first audio file to produce first updated digital content; and
sending, by the computing device, the first updated digital content to the first user computing device.

2. The method of claim 1 further comprises:
determining, by the computing device, a second audio file for a second user computing device based on the desired reaction and a second user reaction profile;
updating, by the computing device, the digital content to include the second audio file to produce second updated digital content; and
sending, by the computing device, the second updated digital content to the second user computing device.

3. The method of claim 1, wherein the first user reaction profile comprises:
a first reaction to a first segment of the digital content; and
a second reaction to a second segment of the digital content.

4. The method of claim 1 further comprises:
implementing a media analysis function to produce media analysis data of the digital content, wherein the media analysis function analyzes the digital content to determine one or more elements of the digital content, wherein the media analysis data includes the one or more elements, and wherein the one or more elements include content type, tone, sentiment and associated audio;
implementing a sentiment analysis function to produce sentiment analysis data regarding the first user, wherein the sentiment analysis function analyzes how the first user reacts to at least one of the one or more elements of the digital content, and wherein the sentiment analysis data includes one or more reactions of the listing of reactions; and
implementing a media reaction correlation function based on the sentiment analysis data and the media analysis data to create or update the first user reaction profile.

5. The method of claim 4 further comprises:
implementing an annotated media analysis function to produce annotated media data regarding second digital content, wherein the annotated media analysis function analyzes the second digital content to determine a second desired reaction for the plurality of users corresponding to one or more annotated elements of the second digital content;
implementing an audio selection function on one or more of the sentiment analysis data, the media analysis data and the annotated media data to produce one or more estimated audio file selections for the one or more annotated elements, wherein the one or more estimated audio files selections is based on the second desired reaction; and
implementing a recommendation function on the one or more estimated audio selections to pair a corresponding audio file of the plurality of audio files with an element of the one or more annotated elements of the second digital content.

6. The method of claim 1 further comprises:
determining, by the computing device, a first genre of a plurality of genres for a first group of user computing devices based on the desired reaction and user reaction profiles associated with the first group of user computing devices;
determining, by the computing device, a second genre of a plurality of genres for a second group of user computing devices based on the desired reaction and user reaction profiles associated with the second group of user computing devices;
selecting, by the computing device, the first audio file based on the first genre;
updating, by the computing device, the digital content to include the first audio file to produce first updated digital content;
sending, by the computing device, the first updated digital content to the first group of user computing devices;
selecting, by the computing device, a second audio file based on the second genre;
updating, by the computing device, the digital content to include the second audio file to produce second updated digital content; and
sending, by the computing device, the second updated digital content to the second group of user computing devices.

7. A computer readable storage device comprises:
a first memory section for storing operational instructions, that when executed by a computing device of a digital communication network, causes the computing device to:
obtain digital content and a desired reaction of a plurality of users for when the digital content is displayed on a plurality of user computing devices, wherein the plurality of users is associated with the plurality of user computing devices;
obtain a plurality of user reaction profiles for the plurality of users, wherein a first user reaction profile is associated with a first user of the plurality of users and wherein the first user is associated with a first user computing device of the plurality of user computing devices;
a second memory section for storing operational instructions, that when executed by the computing device, causes the computing device to:
determine a first audio file of a plurality of audio files for the first user computing device based on the desired reaction and the first user reaction profile, wherein the first user reaction profile includes a listing of reactions of the first user to a variety of audible variances;
update the digital content to include the first audio file to produce first updated digital content; and
a third memory section for storing operational instructions, that when executed by the computing device, causes the computing device to:
send the first updated digital content to the first user computing device.

8. The computer readable storage device of claim 7 further comprises a fourth memory section for storing operational instructions, that when executed by the computing device, causes the computing device to:
determine a second audio file for a second user computing device based on the desired reaction and a second user reaction profile;
update the digital content to include the second audio file to produce second updated digital content; and
send the second updated digital content to the second user computing device.

9. The computer readable storage device of claim 7, wherein the first memory section for stores further operational instructions, that when executed by the computing device, causes the computing device to create or update the first user reaction profile by determining:
a first reaction to a first segment of the digital content; and
a second reaction to a second segment of the digital content.

10. The computer readable storage device of claim 7 further comprises:
a fifth memory section for storing operational instructions, that when executed by the computing device, causes the computing device to:
implement a media analysis function to produce media analysis data of the digital content, wherein the media analysis function analyzes the digital content to determine one or more elements of the digital content, wherein the media analysis data includes the one or more elements, and wherein the one or more elements include content type, tone, sentiment and associated audio;
implement a sentiment analysis function to produce sentiment analysis data regarding the first user, wherein the sentiment analysis function analyzes how the first user reacts to at least one of the one or more elements of the digital content, and wherein the sentiment analysis data includes one or more reactions of the listing of reactions; and
implement a media reaction correlation function based on the sentiment analysis data and the media analysis data to create or update the first user reaction profile.

11. The computer readable storage device of claim 10 further comprises:
a sixth memory section for storing operational instructions, that when executed by the computing device, causes the computing device to:
implement an annotated media analysis function to produce annotated media data regarding future digital content, wherein the annotated media analysis function analyzes the future digital content to determine one or more second elements of the future digital content, wherein the annotated media data includes the one or more second elements, wherein the one or more second elements includes a second desired reaction, wherein the second desired reaction includes a desired reaction annotation for the first user;
implement an audio selection function on one or more of the sentiment analysis data, the media analysis data and the annotated media data to produce one or more estimated audio selections for the one or more second elements, wherein the one or more estimated audio selections is based on one or more of the second desired reaction and the desired reaction annotation; and
implement a recommendation function on the one or more estimated audio selections to pair a corresponding audio file of the plurality of audio files with an element of the one or more elements of the digital content.

12. The computer readable storage device of claim 7 further comprises:
a seventh memory section for storing operational instructions, that when executed by the computing device, causes the computing device to:
determine a first genre of a plurality of genres for a first group of user computing devices based on the desired reaction and user reaction profiles associated with the first group of user computing devices;
determine a second genre of a plurality of genres for a second group of user computing devices based on the desired reaction and user reaction profiles associated with the second group of user computing devices;
select the first audio file based on the first genre;
update the digital content to include the first audio file to produce first updated digital content;
send the first updated digital content to the first group of user computing devices;
select a second audio file based on the second genre;
update the digital content to include the second audio file to produce second updated digital content; and
send the second updated digital content to the second group of user computing devices.

13. A computing device of a digital communication network comprises:
memory;
an interface; and
a processing module operably coupled to the memory and the interface, wherein the processing module is operable to:
obtain digital content and a desired reaction of a plurality of users for when the digital content is displayed on a plurality of user computing devices, wherein the plurality of users is associated with the plurality of user computing devices;
obtain a plurality of user reaction profiles for the plurality of users, wherein a first user reaction profile is associated with a first user of the plurality of users and wherein the first user is associated with a first user computing device of the plurality of user computing devices;
determine a first audio file of a plurality of audio files for the first user computing device based on the desired reaction and the first user reaction profile, wherein the first user reaction profile includes a listing of reactions of the first user to a variety of audible variances;
update the digital content to include the first audio file to produce first updated digital content; and
send, via the interface, the first updated digital content to the first user computing device.

14. The computing device of claim 13, wherein the processing module is further operable to:
determine a second audio file for a second user computing device based on the desired reaction and a second user reaction profile;
update the digital content to include the second audio file to produce second updated digital content; and
send, via the interface, the second updated digital content to the second user computing device.

15. The computing device of claim 13, wherein the processing module is further operable to create or update the first user reaction profile by determining:
a first reaction to a first segment of the digital content; and
a second reaction to a second segment of the digital content.

16. The computing device of claim 13 further comprises:
a media analysis module that is operable to implement a media analysis function to produce media analysis data of the digital content, wherein the media analysis function analyzes the digital content to determine one or more elements of the digital content, wherein the media analysis data includes the one or more elements, and wherein the one or more elements include content type, tone, sentiment and associated audio;
a sentiment analysis module that is operable to implement a sentiment analysis function to produce sentiment analysis data regarding the first user, wherein the sentiment analysis function analyzes how the first user reacts to at least one of the one or more elements of the digital content, and wherein the sentiment analysis data includes one or more reactions of the listing of reactions; and
a media reaction correlation module that is operable to implement a media reaction correlation function based on the sentiment analysis data and the media analysis data to create or update the first user reaction profile.

17. The computing device of claim 16 further comprises:
an annotated media analysis module that is operable to implement an annotated media analysis function to produce annotated media data regarding future digital content, wherein the annotated media analysis function analyzes the future digital content to determine one or more second elements of the future digital content, wherein the annotated media data includes the one or more second elements, wherein the one or more second elements includes a second desired reaction, wherein the second desired reaction includes a desired reaction annotation for the first user;
an audio selection module that is operable to implement an audio selection function on one or more of the sentiment analysis data, the media analysis data and the annotated media data to produce one or more estimated audio selections for the one or more second elements, wherein the one or more estimated audio selections is based on one or more of the second desired reaction and the desired reaction annotation; and
a recommendation module that is operable to implement a recommendation function on the one or more estimated audio selections to pair a corresponding audio file of the plurality of audio files with an element of the one or more elements of the digital content.

18. The computing device of claim 13, wherein the processing module is further operable to:
determine a first genre of a plurality of genres for a first group of user computing devices based on the desired reaction and user reaction profiles associated with the first group of user computing devices;
determine a second genre of a plurality of genres for a second group of user computing devices based on the desired reaction and user reaction profiles associated with the second group of user computing devices;
select the first audio file based on the first genre;
update the digital content to include the first audio file to produce first updated digital content;
send, via the interface, the first updated digital content to the first group of user computing devices;
select a second audio file based on the second genre;
update the digital content to include the second audio file to produce second updated digital content; and
send, via the interface, the second updated digital content to the second group of user computing devices.
